(19) United States
(12) Patent Application Publication
(10) Pub. No.: US 2024/0241615 A1
(43) Pub. Date: Jul. 18, 2024

(54) CURSOR TRANSPORT

(71) Applicant: APPLE INC., Cupertino, CA (US)

(72) Inventors: Jack H. LAWRENCE, San Francisco, CA (US); Mark A. EBBOLE, San Francisco, CA (US)

(21) Appl. No.: 18/410,601

(22) Filed: Jan. 11, 2024

Related U.S. Application Data
(60) Provisional application No. 63/438,556, filed on Jan. 12, 2023.

(51) Int. Cl. G06F 3/04812; G06F 3/04815

(52) U.S. Cl. CPC G06F 3/04812; G06F 3/04815; G06F 3/012

(57) ABSTRACT

Various implementations disclosed herein include devices, systems, and methods that transport a cursor between surfaces of objects within an XR environment. For example, an example process may include displaying a movement of a cursor across a first surface of a first object in a view of a three-dimensional (3D) environment. The process may further include determining that movement of the cursor approaches or intersects a boundary of the first surface at a first position. The process may further include determining a second position on a second surface of a second object in the 3D environment based on a path of the cursor. The process may further include moving the cursor from the first position to the second position.

### CROSS-REFERENCE TO RELATED APPLICATIONS

This Application claims the benefit of U.S. Provisional Application Ser. No. 63/438,556 filed Jan. 12, 2023, which is incorporated herein in its entirety.

### TECHNICAL FIELD

The present disclosure generally relates to systems, methods, and devices such as head-mounted devices (HMDs) that enable movement of a cursor between surfaces of objects within an extended reality (XR) environment.

### BACKGROUND

To enable cursor movement within a three-dimensional (3D) environment presented via devices such as HMDs, it may be desirable to enable a user to move a cursor between objects, such as separated user interface objects, with the 3D environment's 3D space. However, existing systems may not adequately enable such movement and/or account for objects located within separated 3D locations and/or on differing planes of the 3D environment.

### SUMMARY

Various implementations disclosed herein include devices, systems, and methods that move a cursor between surfaces of objects in an XR environment. Some implementations move (e.g., transport, reposition, etc.) a cursor from a first surface to a second surface in an XR environment such that when the cursor reaches a boundary of the first surface, a path of the cursor is used to determine a cursor starting position on the second surface. The path may be a line corresponding to the cursor movement on a two-dimensional (2D) representation of relative positions of the surfaces, e.g., a projection of the surfaces onto a plane such as a parallel plane. For example, a device (e.g., a computer, laptop, phone, tablet, HMD, and the like) may be enabled to generate a projection of surfaces of objects located within differing planes of an XR environment onto a 5 parallel plane providing the surfaces with respect to a (2D) plane. The projection onto a 2D plane may facilitate identifying a path between surfaces of the objects to enable cursor movement between the objects such that when the cursor reaches a first position at a boundary of a surface of a first object, the path of the cursor is used to determine starting position of the cursor on a surface of a second object. Determining a path and corresponding cursor movement (e.g., ending and starting positions) using a 2D projection plane may provide cursor movements between objects in 3D space that are intuitive and/or otherwise consistent with user expectations. In some implementations, moving the cursor from the first position of the surface of the first object to the starting position of the surface of the second object comprises discontinuing display of the cursor at the first position and initiating display of the cursor at the starting position without displaying the cursor between the first position and the starting position. Moving a cursor by discontinuing display of the cursor on a first surface and then initiating display of the cursor at a starting position on a second object that is based on a path on a 2D projection plane may provide cursor movements between objects in 3D space that are intuitive and/or otherwise consistent with user expectations.

In some implementations, the projection is an orthographic projection onto a plane that is independent from a user viewpoint. In some implementations, the orthographic projection is onto a plane defined based on an orientation of a user interface object. In some implementations, objects of the XR environment are flat user interface objects such as windows, individual application components, independent applications, etc. In some implementations, surfaces of objects in the XR environment are non-contiguous, i.e., separated by distances within the XR environment. In some implementations, the separated surfaces are planar surfaces oriented in different (non-parallel) directions, i.e., surfaces of planar objects that are not parallel to one another. In some implementations, the cursor may be initially displayed at an initial position on an initial surface of an object in response to a gaze of a user.

In some implementations, an electronic device has a display and a processor (e.g., one or more processors) that executes instructions stored in a non-transitory computer-readable medium to perform a method. The method performs one or more steps or processes. In some implementations, movement of a cursor is displayed across a first surface of a first object in a view of a three-dimensional (3D) environment via the display. Movement of the cursor approaching or intersecting a boundary of the first surface at a first position is determined. In accordance with determining that the movement of the cursor approaches or intersects the boundary of the first surface: a second position on a second surface of a second object in the 3D environment is determined based on a path of the cursor and the cursor is moved from the first position to the second position.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is an example extended reality (XR) environment presented to a user via a head mounted display (HMD), in accordance with some implementations.

FIGS. 2A-2B illustrate utilization of a path on a 2D projection to determine cursor movement, in accordance with some implementations.

FIGS. 2C-2D illustrate alternative curser movement with respect to the curser movement described with respect to FIGS. 2A-2B, in accordance with some implementations.

FIG. 3 illustrates a system flow diagram of an example environment in which a system leverages an orthographic projection of surfaces of objects in a 3D environment onto a (2D) plane, in accordance with some implementations.

FIG. 4 is a flowchart representation of an exemplary method for transporting a cursor between surfaces of objects within an XR environment.

FIG. 5 illustrates an exemplary device configuration in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

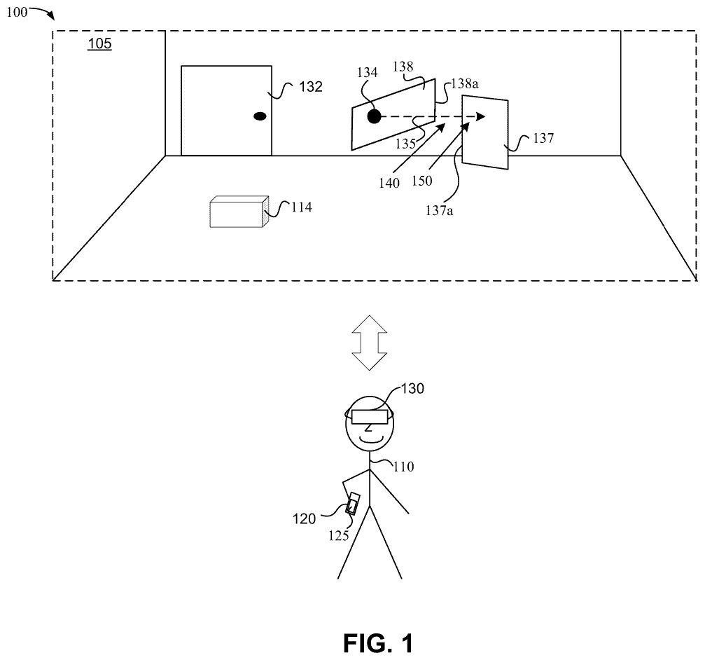

FIG. 1 illustrates a view 100 of an example extended reality (XR) environment 105 (e.g., an environment based on objects of a physical environment and/or virtual objects) presented to a user 110 via a head mounted display (HMD). The XR environment 105 may include virtual reality (VR) content, mixed reality (MR) content, augmented reality (AR) content, or the like. In this example, the XR environment 105 includes an object (e.g., a door) 132, an object (e.g., a box) 114, an object 138 (e.g., a user interface, a display, etc.), a cursor 134 (e.g., a pointer or indicator for illustrating a position of user interaction within the XR environment 105 in response to user input), and an object 137 (e.g., a user interface, etc.). Object 114, object 132, object 137, and/or object 138 may each comprise a real object viewed though pass through video provided by an electronic device (e.g., an HMD) 130. As an alternative, object 114, object 132, object 137, and/or object 138 may each comprise a virtual object generated and presented by the HMD 130. In some implementations, the HMD 130 may enable movement of the cursor 134 throughout the XR environment 105 with respect to interacting with 3D objects within the XR environment 105 (e.g., object 132, object 114, object 137, and/or object 138).

The HMD 130 may include one or more cameras, microphones, depth sensors, or other sensors that may be used to capture information about and evaluate the XR environment 105 and the objects within it, as well as information about the user 110 of the HMD 130. The information about the XR environment 105 and/or user 110 may be used to provide visual and audio content (e.g., a user interface), to identify the current location of a physical environment or the XR environment 105, and/or for other purposes.

In some implementations, views (e.g., view 100) of the XR environment 105 may be provided to one or more participants (e.g., user 110 and/or other participants not shown). The XR environment 105 may include views of a 3D environment that is generated based on camera images and/or depth camera images of a physical environment as well as a representation of the user 110 based on camera images and/or depth camera images of the user 110. Such an XR environment 105 may include virtual content that is positioned at 3D locations relative to a 3D coordinate system associated with the XR environment 105, which may correspond to a 3D coordinate system of a physical environment.

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device such as, inter alia, HMD 130. Using an XR system, a portion of a person's physical motions, or representations thereof, may be tracked and, in response, properties of virtual objects in the XR environment 105 may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, HMD, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems (e.g., HMD 130), a track pad (e.g., track pad 125 of device 120), foot pedals, a series of buttons mounted near a user's head, neurological sensors, etc. to control a cursor for selecting user content, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

In some implementations, the HMD 130 is configured to present or display the cursor 134 to enable user interactions with surfaces of content items such as objects 114, 132, 137, and/or 138 of FIG. 1. In some implementations, objects 137 and/or 138 may be portions of a virtual user interface displayed to the user 110. Likewise, the cursor 134 may be displayed on the virtual user interface and may be moved within the XR environment 105 in response to user input received via, inter alia, hand gestures, trackpad input, mouse input, gaze-based input, voice commands, foot pedals, a series of buttons mounted near a user's head, neurological sensors, etc.

In the example of FIG. 1, a virtual user interface may include various content and user interface elements, including virtual buttons, a keyboard, a scroll bar, etc. Interactions with the virtual user interface may be initiated by the user 110 to provide input to which the virtual user interface responds. A virtual user interface may comprise one or more objects that are flat (e.g., planar or curved planar without depth) or 3 dimensional.

The virtual user interface may be a user interface of an application. The virtual user interface is simplified for purposes of illustration and user interfaces in practice may include any degree of complexity, any number of user interface elements, and/or combinations of 2D and/or 3D content. The virtual user interface may be provided by operating systems and/or applications of various types including, but not limited to, messaging applications, web browser applications, content viewing applications, content creation and editing applications, or any other applications that can display, present, or otherwise use visual and/or audio content.

In some implementations, multiple user interfaces (e.g., corresponding to multiple, different applications) are presented sequentially and/or simultaneously within XR environment 105 using one or more flat background portions. In some implementations, the positions and/or orientations of such one or more virtual user interfaces may be determined to facilitate visibility and/or use. The one or more virtual user interfaces may be at fixed positions and orientations within the 3D environment. In such cases, user movements would not affect the position or orientation of the user interfaces within the 3D environment.

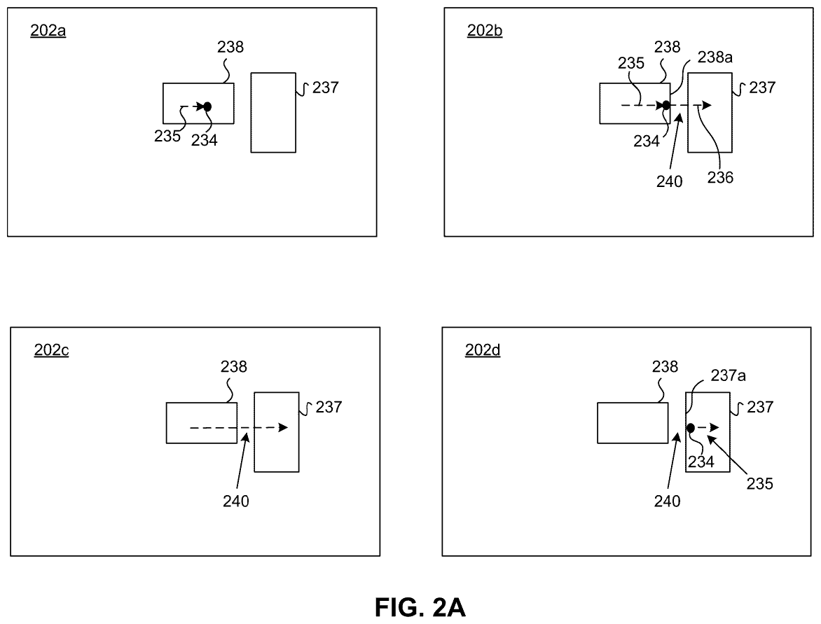

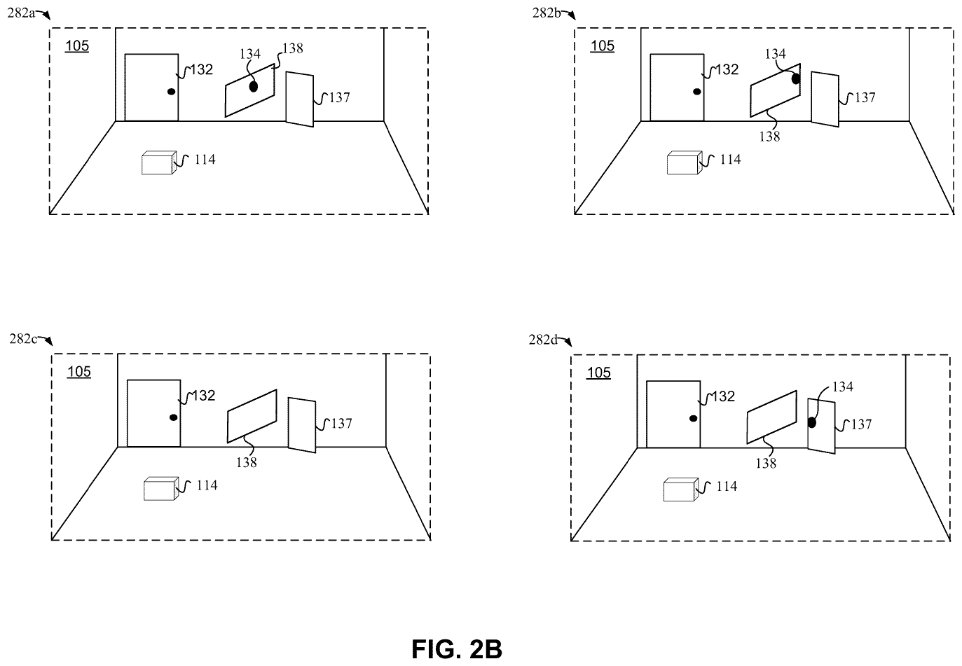

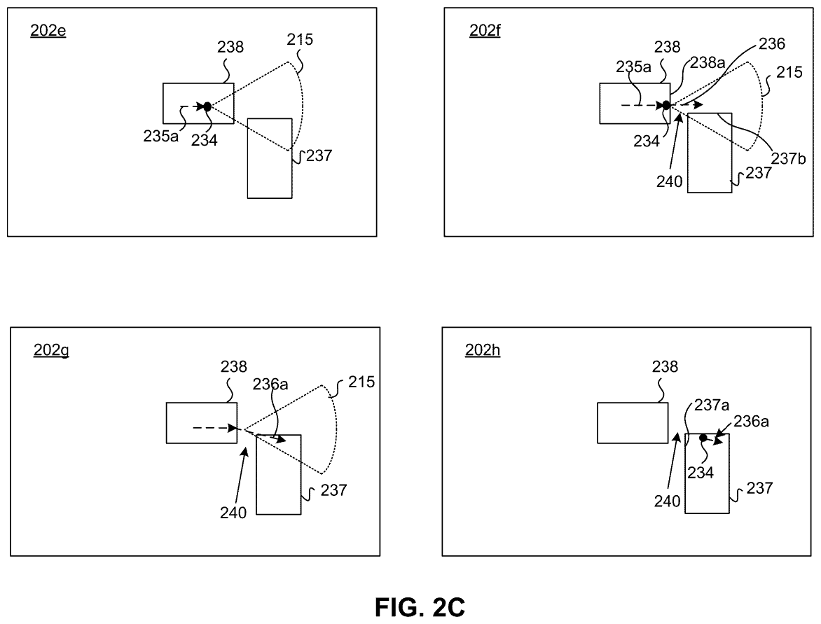

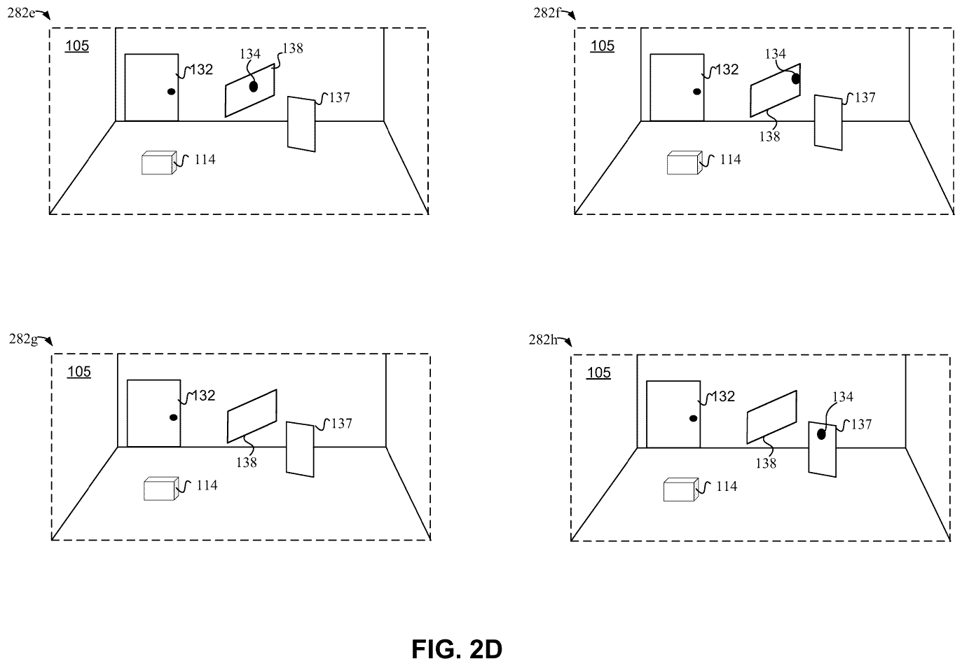

In some implementations, the HMD 130 enables movement of the cursor 134 between objects 114, 132, 137, and/or 138 within the XR environment 105. In some implementations, the cursor may appear to warp or transport between discontiguous surfaces of objects 114, 132, 137, and/or 138. For example (as illustrated in FIG. 1), the cursor 134 may be moved from a surface of the object 138 to a surface of the object 137 (without displaying cursor movement across a gap 140 extending a distance between non-contiguous objects 138 and 137) in a direction in accordance with a path 135. In response to the cursor 134 approaching or intersecting a boundary 138a of the object 138, the path 135 may be used to indicate where the cursor 134 will intersect a boundary 137a of object 137. The path may additionally enable a process to determine a starting position 150 for presenting the cursor on object 137 (after non-contiguous movement from the object 138). The path 135 may comprise a line corresponding to cursor movement on a 2D plane having representations of planar relationships for non-planar objects, e.g., on an orthographic projection of the objects 137 and 138 (and/or objects 114 and 132) onto a parallel plane as described with respect to FIGS. 2A-2D, infra. Generating an orthographic projection onto a parallel plane may include projecting objects 137 and 138 (of XR (3D) environment 105) onto a 2-dimensional (2D) plane to determine attributes associated with transporting the cursor 134. In some implementations, the orthographic projection is projected onto a 2D plane independent of a user viewpoint. Alternatively, a projection may be projected onto a 2D plane defined based on an orientation of a user interface object (e.g., object 137 or object 138).

A curser warping or transporting process is only enabled with respect to dis-contiguous surfaces of objects (e.g., a virtual structure) such as a surface of object 138 and a surface of object 137. If surfaces of objects overlap each other, normal curser movement is enabled such that a curser may freely move across the overlapping surfaces of the objects. For example, if a cursor is located on a first virtual structure (a small alert window) hovering in front or above a second virtual structure (e.g., a larger application window) and the cursor reaches a boundary of the first virtual structure, the warping process is initially enabled until it is determined that a path between the first virtual structure and the second virtual structure is contiguous. In response, the warping process is disabled, and the cursor can move from the first virtual surface to the second virtual surface without warping.

In some implementations (during movement of the cursor 134 over a first virtual structure within the XR environment 105), it may be determined that there are no additional virtual structures located adjacent to the first virtual structure. In this instance, the curser 134 adjacent to is clamped (e.g., locked) to a boundary of the first virtual structure to prevent further movement of the curser such that that the cursor 134 does not float over empty space (e.g., without virtual structures) within the XR environment 105.

FIGS. 2A-2B illustrate utilization of a path 235 on a projection (from a 3D environment such as XR environment 105 of FIG. 1) to determine cursor 134 movement. FIG. 2A illustrates a projection onto a projection plane to move a cursor representation 234 from a representation 238 (corresponding to object 138 of FIG. 1) to a representation 237 (corresponding to object 137 of FIG. 1). The corresponding objects 137, 138 (FIG. 2B) are not located in a same plane within the 3D environment, but the representations 237, 238 are located in the same plane of the orthographic projection. FIG. 2A illustrates several views of the orthographic projection. The orthographic projection (view 202a, view 202b, view 202c, and view 202d) include a representation 238 of an object (e.g., a user interface) 138 and a representation 137 of an object (e.g., a user interface) 237.

In FIG. 2A, at a first instant in time corresponding to view 202a, a user (e.g., user 110 of FIG. 1) has provided cursor-moving input (e.g., using their hand to provide input via trackpad 125 of FIG. 1) corresponding to a position of the cursor representation 234 located at a specified location on the object (e.g., a user interface) 238. Movement of the hand of the user or other cursor-moving input may be tracked with respect to movement of the cursor 234 to identify cursor movement and user interactions with respect to the object currently associated with cursor, e.g., object 238 in view 202a. In this example, view 202a illustrates a position of a representation 234 of a cursor 134 after being moved from its initial position along path 235. In some implementations, the initial position is determined based on a default location, such as a center of the screen, or an input modality (e.g., based on a finger or gaze location) and subsequent movement is based on another input modality (e.g., based on trackpad user input).

FIG. 2B illustrates a view 282a of the XR environment 100 corresponding to the view 202a of the projection illustrated in FIG. 2A. In this example, the cursor 134 is positioned at a position on the object 138 corresponding to and/or based on the position of the cursor representation 234 on the representation 238 that corresponds to object 138.

In FIG. 2A, at a second instant in time corresponding to view 202b, the example illustrates that the user has moved their hand on the trackpad or provided other cursor-moving input causing the representation 234 (corresponding to cursor 134) to continue moving along path 235 and contact (or approach) a boundary 238a of the representation 238. In response, the cursor 234 initiates a process for moving (e.g., via a warping process) across a gap 240 (extending across a distance that is not occupied by a representation on the projection) located between the representation 238 and the representation 237. A path extension 236 is determined. In this example, path extension 236 is determined by extending path 235 linearly beyond the current position of the cursor representation 234. The path extension 236 follows a direction with respect to a user input command. For example, the path extension 236 may follow a direction in response to user movement (e.g., a path of movement of a finger along a trackpad) with respect to an input device receiving input associated with curser movement.

FIG. 2B illustrates a view 282b of the XR environment 100 corresponding to the view 202b of the projection illustrated in FIG. 2A. In this example, the cursor 134 is positioned at a position on the object 138 corresponding to and/or based on the position of the cursor representation 234 on the representation 238 that corresponds to object 138.

In FIG. 2A, in response to contact or approaching/expected contact (of the cursor representation 234) with the boundary 238a, at a third instant in time corresponding to view 202c, the cursor representation 234 is warped, transported, or any other similar jumping approach to the representation 237 where the cursor will appear at a first location and then thereafter appear at a second location different from, and not directly adjacent to, the first location. Cursor representation 234 movement between separated objects may be instantaneous or may include a time delay based on the distance of separation, e.g., the size of gap 240. During cursor representation movement between separated objects, the corresponding cursor 134 (FIG. 1) may or may not be visible. In some implementations, a line or other indication of cursor movement/transport may be presented to indicate travel of the cursor between separated objects.

FIG. 2B illustrates a view 282c of the XR environment 100 corresponding to the view 202c of the projection illustrated in FIG. 2A. In this example, the cursor 134 is not displayed in this example. In some implementations, cursor 134 transport between objects 138, 137 is instantaneous and thus the cursor 134 is continuously displayed, e.g., being displayed in one frame on object 138 and the next frame on object 137.

In FIG. 2A, at a fourth instant in time corresponding to view 202d, the representation 234 is transported/warped to representation 237. It's position on representation 237 may be determined based on path 235/path extension 236, e.g., by determining an intersection of path 235/path extension 236 with object boundary 237a of object 237. Subsequently, the cursor representation 234 may further travel based on user cursor-moving input towards any additional representations such as representation 238 and representation 237.

FIG. 2B illustrates a view 282d of the XR environment 100 corresponding to the view 202d of the projection illustrated in FIG. 2A. In this example, the cursor 134 is positioned at a position on the object 137 corresponding to and/or based on the position of the cursor representation 234 on the representation 237 that corresponds to object 137.

FIGS. 2C-2D illustrate an alternative curser 134 movement with respect to the curser 134 movement described with respect to FIGS. 2A-2B. Curser 134 movement illustrated in FIGS. 2C-2D utilizes an area bounded by a 2D cone structure 215 to rectify inaccuracies with respect to user input such that if a user does not move the cursor 134 in a direction of adjacent objects (e.g., objects 137 and 138 of FIG. 1), a direction of a path of the curser 134 may be modified within the area bounded by the cone structure 215 to locate an adjacent object surface to warp onto (e.g., to determine user intent with respect to curser 134 movement onto an adjacent object surface).

FIGS. 2C-2D illustrate utilization of a path 235a and 2D cone structure 215 on a projection (from a 3D environment such as XR environment 105 of FIG. 1) to determine cursor 134 movement. FIG. 2C illustrates a projection onto a projection plane to move cursor representation 234 from a representation 238 (corresponding to object 138 of FIG. 1) to a representation 237 (corresponding to object 137 of FIG. 1 located in a differing position (e.g., a position that is not located within a directional path (e.g., path 235a) of curser 134 movement). The corresponding objects 137, 138 (FIG. 2D) are not located in a same plane within the 3D environment, but the representations 237, 238 are located in the same plane of the orthographic projection. FIG. 2C illustrates several views of the orthographic projection. The orthographic projection (view 202e, view 202f, view 202g, and view 202h) include a representation 238 of an object (e.g., a user interface) 138 and a representation 137 of an object (e.g., a user interface) 237.

In FIG. 2C, at a first instant in time corresponding to view 202e, a user (e.g., user 110 of FIG. 1) has provided cursor-moving input (e.g., using their hand to provide input via trackpad 125 of FIG. 1) corresponding to a position of the cursor representation 234 located at a specified location on the object (e.g., a user interface) 238. Movement of the hand of the user or other cursor-moving input may be tracked with respect to movement of the cursor 234 to identify cursor movement and user interactions with respect to the object currently associated with cursor, e.g., object 238 in view 202e. In this example, view 202e illustrates a position of a representation 234 of a cursor 134 after being moved from its initial position along path 235a. In some implementations, the initial position is determined based on a default location, such as a center of the screen, or an input modality (e.g., based on a finger or gaze location) and subsequent movement is based on another input modality (e.g., based on trackpad user input).

FIG. 2D illustrates a view 282e of the XR environment 100 corresponding to the view 202e of the projection illustrated in FIG. 2C. In this example, the cursor 134 is positioned at a position on the object 138 corresponding to and/or based on the position of the cursor representation 234 on the representation 238 that corresponds to object 138.

In FIG. 2C, at a second instant in time corresponding to view 202f, the example illustrates that the user has moved their hand on the trackpad or provided other cursor-moving input causing the representation 234 (corresponding to cursor 134) to continue moving along path 235a and contact (or approach) a boundary 238a of the representation 238. In response, the cursor 234 initiates a process for moving (e.g., via a warping process) into a gap 240 (extending into an area that is not occupied by a representation on the projection) located adjacent to boundary 238a (of the representation 238) and above a boundary 237b of the representation 237. A path extension 236 is determined. In this example, path extension 236 is determined by extending path 235a linearly beyond the current position of the cursor representation 234 and into an area bounded by cone structure 215. In this instance, it is determined (via path extension 236) that representation 237 (corresponding to object 137) is not directionally located within path extension 236 of path 235a. Therefore, a direction of path extension 236 must be modified (via usage of cone structure 215) to allow the representation 234 (corresponding to cursor 134) to warp (across gap 240) to representation 237 (corresponding to object 137) as described, infra.

FIG. 2D illustrates a view 282f of the XR environment 105 corresponding to the view 202f of the projection illustrated in FIG. 2C. In this example, the cursor 134 is positioned at a position on the object 138 corresponding to and/or based on the position of the cursor representation 234 on the representation 238 that corresponds to object 138.

In FIG. 2C, in response to contact or approaching/expected contact (of the cursor representation 234) with the boundary 238a and determining that representation 237 (corresponding to object 137) is not directionally located within a path of path extension 236 of path 235a, at a third instant in time corresponding to view 202g, a direction of path extension 236 is modified (becoming path extension 236a) within an area bounded by cone structure 215. An original direction of path extension 236 and a current direction of (modified) path extension 236a are determined by following a direction(s) with respect to a user input command. For example, the path extensions 236 and 236a may follow a direction(s) in response to user movement (e.g., a path of movement of a finger along a trackpad) with respect to an input device receiving input associated with curser movement. A direction of path 236a may be determined by detecting a representation of an object (e.g., representation 237 of object 137) that is located adjacent to an original path direction (e.g., of original path extension 236) within the area bounded by cone structure 215. If it is determined that multiple representations of objects exist adjacent to representation 237 of object 137 within the area bounded by cone structure 215, then a direction of path 236a may be determined based on detecting which object representation is located closer to: representation 237, an original path direction (e.g., of original path extension 236), etc. Alternatively, if it is determined that multiple representations of objects exist adjacent to representation 237 of object 137 within the area bounded by cone structure 215, then a direction of path 236a may be determined based on based on a user input movement (e.g., movement of a user finger) direction occurring when cursor representation 234 is located within gap 240 and/or is adjacent to any boundaries of object 237.

Travel along path extension 236a allows the cursor representation 234 to be transported to the representation 237. Cursor representation 234 movement between separated objects may be instantaneous or may include a time delay based on the distance of separation, e.g., the size of gap 240 and a time to directionally modify path extension 236. During cursor representation movement between separated objects, the corresponding cursor 134 (FIG. 1) may or may not be visible. In some implementations, a line, cone, or other indication of cursor movement/transport may be presented to indicate travel of the cursor between separated objects.

FIG. 2D illustrates a view 282f of the XR environment 105 corresponding to the view 202g of the projection illustrated in FIG. 2C. In this example, the cursor 134 is not displayed in this example. In some implementations, cursor 134 transport between objects 138, 137 is instantaneous and thus the cursor 134 is continuously displayed, e.g., being displayed in one frame on object 138 and the next frame on object 137.

In FIG. 2C, at a fourth instant in time corresponding to view 202h, the representation 234 is transported/warped to representation 237. It's position on representation 237 may be determined based on path 235a/path extension 236/236a, e.g., by determining an intersection of path 235/path extension 236a with object boundary 237a of object 237. Subsequently, the cursor representation 234 may further travel based on user cursor-moving input towards any additional representations such as representation 238 and representation 237.

FIG. 2D illustrates a view 282h of the XR environment 105 corresponding to the view 202h of the projection illustrated in FIG. 2C. In this example, the cursor 134 is positioned at a position on the object 137 corresponding to and/or based on the position of the cursor representation 234 on the representation 237 that corresponds to object 137.

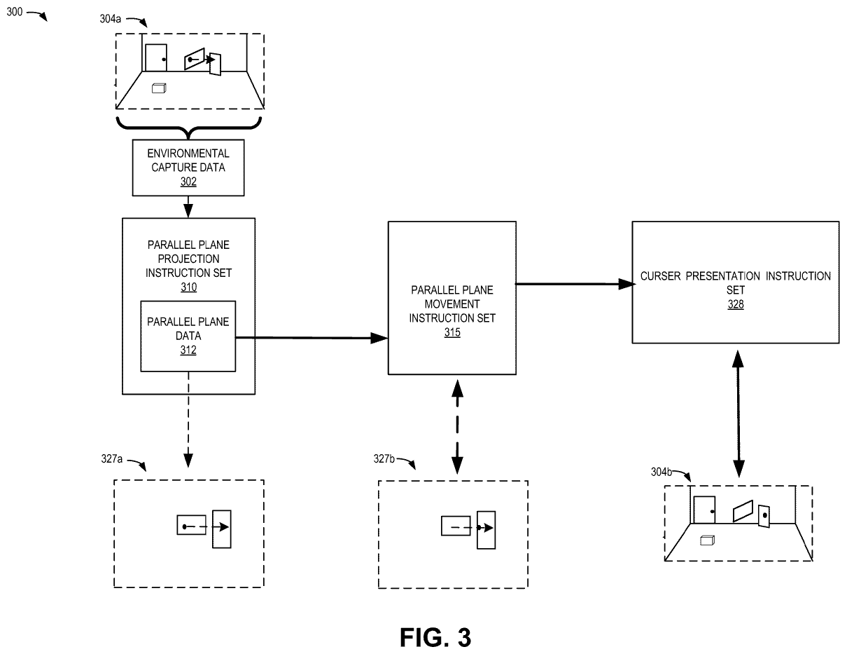

FIG. 3 illustrates a system flow diagram of an example system 300 in which a system leverages an orthographic projection of surfaces of 3D user interface objects in a 3D environment (of an XR environment such as XR environment 105 of FIG. 1) onto a (2D) plane to enable seamless movement (e.g., warping or transporting) of a cursor between the 3D user interface objects in the 3D environment. In some implementations, the system flow of the example system 300 is performed on a device, such as an HMD (e.g., HMD 130 of FIG. 1). Any images of the example system 300 may be displayed on the device that has a screen for displaying images and/or a screen for viewing stereoscopic images such as an HMD. In some implementations, the system flow of the example system 300 is performed on processing logic, including hardware, firmware, software, or a combination thereof. In some implementations, the system flow of the example system 300 is performed on a processor executing code stored in a non-transitory computer-readable medium (e.g., a memory).

The overall system flow of the example system 300 executes a process that acquires environmental capture data 302 (e.g., image data, depth data, virtual object position and orientation data, etc.) from sensors for an XR environment and enables an orthographic projection of surfaces of objects in a 3D environment onto a parallel (2D) plane. The process may be further configured to enable cursor movement between the objects in the 3D environment (e.g., located in different planes) by using the parallel plane in combination with a projected line describing a cursor travel path to determine cursor movement. The cursor movement is presented to the user using a device via the XR environment.

In some implementations, the overall system flow of the example system 300 may execute a process that acquires environmental capture data 302 (e.g., image data, depth data, virtual object position and orientation data, etc.) from sensors for an XR environment and generates a model for presenting content to the user (e.g., to enhance an extended reality (XR) environment).

In an example implementation, the system 300 includes an image composition pipeline that acquires or obtains data (e.g., image data from image source(s)) of a physical environment from a sensor on a device (e.g., HMD 130 of FIG. 1) as environmental capture data 302. Environmental capture data 302 is an example of acquiring image sensor data (e.g., light intensity data, depth data, and position information) for a plurality of image frames. For example, a user may acquire image data as the user is in a room in a physical environment. The images of the environmental capture data can be displayed on the device that has a screen for displaying images and/or a screen for viewing stereoscopic images such as an HMD. The image source(s) may include a depth camera that acquires depth data of the physical environment, a light intensity camera (e.g., RGB camera) that acquires light intensity image data (e.g., a sequence of RGB image frames), and position sensors to acquire positioning information. For the positioning information, some implementations include a visual inertial odometry (VIO) system to determine equivalent odometry information using sequential camera images (e.g., light intensity data) to estimate the distance traveled.

In an example implementation, the system 300 includes a parallel plane projection instruction set 410 that is configured with instructions executable by a processor to generate a parallel (2D) plane. The parallel plane projection instruction set 310 obtains environmental capture data 302 and generates parallel plane data 312. For example, the parallel plane projection instruction set 310 may analyze environmental capture data 302 for a particular room and generate a corresponding parallel (2D) plane for that particular room (e.g., parallel (2D) plane model 327a). Thus, the parallel plane data 312 includes a generated parallel (2D) plane model 327a for virtual user interface objects in an environment included in the environmental capture data 302. In some implementations, the generated parallel (2D) plane model 327a includes all 3D virtual user interface objects and a cursor of a 3D environment transformed into a 2D plane as described supra with reference to FIGS. 2A-2D. The parallel (2D) plane model 327a may identify the locations of the objects within a 3D or 2D coordinate system. In one example, such locations are relative to a 3D coordinate system corresponding to an XR environment. In another example, such locations are relative to a 2D top-down floor plan coordinate system of the XR environment.

In an example implementation, the system flow of the example environment 400 includes a parallel plane movement instruction set 315 that is configured with instructions executable by a processor to enable movement of a cursor between objects within an XR environment 304a. In some implementations, the cursor may appear to warp or transport between surfaces of objects without displaying cursor movement across a gap extending a non-contiguous distance between objects in a direction in accordance with a projected path. The cursor reappears on another object in accordance with a projected path as illustrated in parallel (2D) plane model 327b.

In an example implementation, the system 300 includes a cursor presentation instruction set 328 that is configured with instructions executable by a processor to present the cursor (subsequent to movement between objects) on an object of XR environment 404b. In some implementations, cursor presentation instruction set 428 is configured to execute an algorithm (implemented via specialized computer code) to retrieve data of the parallel (2D) plane model 327b and convert the data into the XR environment 304b for presentation to a user.

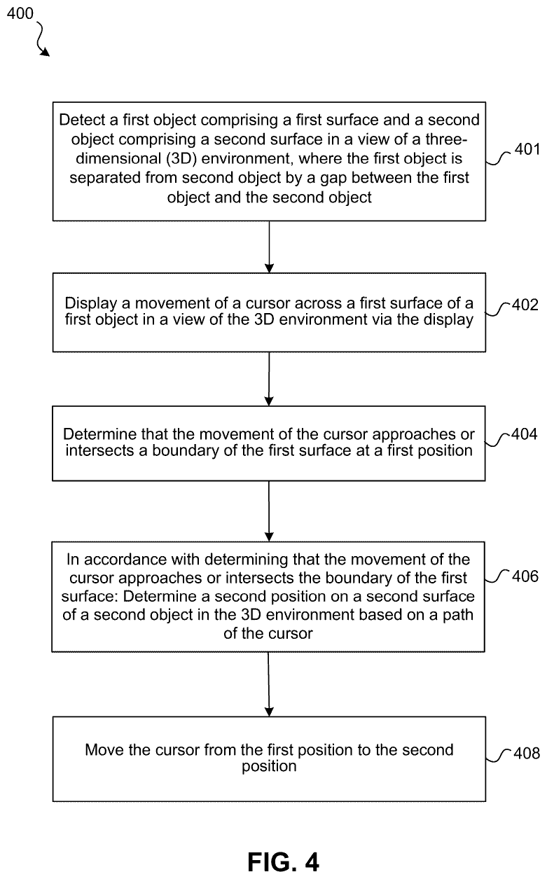

FIG. 4 is a flowchart representation of an exemplary method 400 for transporting a cursor between surfaces of objects (such as user interfaces) within an XR environment. In some implementations, the method 400 is performed by an electronic device (e.g., HMD 130 of FIG. 1) having a processor and a display. In some implementations, the method 400 is performed by processing logic, including hardware, firmware, software, or a combination thereof. In some implementations, the method 400 is performed by a processor executing code stored in a non-transitory computer-readable medium (e.g., a memory). Each of the blocks in the method 400 may be enabled and executed in any order.

At block 401, the method 400 detects a first object comprising a first surface and a second object comprising a second surface in a view of a three-dimensional (3D) environment. In some implementations the first object is separated from second object by a gap between the first object and the second object.

At block 402, the method 400 displays a movement of a cursor across a first surface of a first object (e.g., a user interface) in a view of a 3D environment (e.g., XR environment) via a display. The cursor may be an indicator illustrating a position of user interaction within an XR environment in response to user input. The cursor may be initially displayed at an initial position on the first surface in response to a gaze or head pose of a user. In some implementations, the initial position is determined based on a default location, such as a center of the screen, or an input modality (e.g., based on a finger or gaze location) and subsequent movement is based on another input modality (e.g., based on trackpad user input).

At block 404, the method 400 determines that the movement of the cursor approaches or intersects a boundary of the first surface (of the first object) at a first position.

At block 406 (in accordance with determining that the movement of the cursor approaches or intersects the boundary of the first surface), the method 400 determines a second position on a second surface of a second object in the 3D environment based on a path of the cursor with respect to an intersection point of a boundary of the second surface.

In some implementations the path may be a line corresponding to the cursor movement on an orthographic projection of the first surface and the second surface. In some implementations the path may be a line based on extending a line segment corresponding to the cursor movement on the orthographic projection. The orthogonal projection may be projected onto a plane that is independent of a user viewpoint. Alternatively, the orthographic projection may be projected onto a plane defined based on an orientation of a user interface object (e.g., a parallel plane).

In some implementations, the first object or the second object may comprise flat user-interface objects such as, inter alia, windows, windows corresponding to separate application components or separate applications, etc.

In some implementations, the first surface (of the first object) and second surface (of the second object) are separated by the gap comprising a non-contiguous distance within the 3D environment. In some implementations, the first surface (of the first object) and second surface (of the second object) may comprise flat surfaces that are separated by the gap comprising a non-contiguous distance from one another in the 3D environment and oriented in different (non-parallel) directions.

At block 408, the method moves the cursor from the first position to the second position. In some implementations, moving the cursor from the first position to the second position may comprise discontinuing display of the cursor at the first position and initiating display of the cursor at the second position without displaying the cursor in the gap between the first position and the second position.

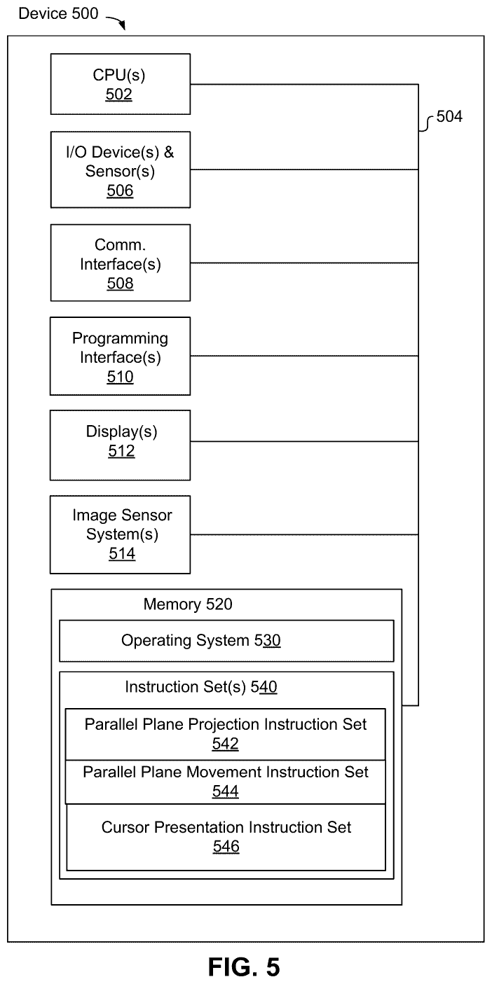

FIG. 5 is a block diagram of an example of a device 500 (e.g., HMD 130 of FIG. 1) in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 500 includes one or more processing units 502 (e.g., microprocessors, ASICs, FPGAs, GPUs, CPUs, processing cores, and/or the like), one or more input/output (I/O) devices and sensors 506, one or more communication interfaces 508 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 510, one or more displays 512, one or more interior and/or exterior facing image sensor systems 514, a memory 520, and one or more communication buses 504 for interconnecting these and various other components.

In some implementations, the one or more communication buses 504 include circuitry that interconnects and controls communications between system components. In some implementations, the one or more I/O devices and sensors 506 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 512 are configured to present a view of a physical environment or a graphical environment to the user. In some implementations, the one or more displays 512 are configured to present content (determined based on a determined user/object location of the user within a physical environment) to the user. In some implementations, the one or more displays 512 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 512 correspond to diffractive, reflective, polarized, holographic, etc. waveguide displays. In one example, the device 500 includes a single display. In another example, the device 500 includes a display for each eye of the user.

In some implementations, the one or more image sensor systems 514 are configured to obtain image data that corresponds to at least a portion of the physical environment 105. For example, the one or more image sensor systems 514 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 514 further include illumination sources that emit light, such as a flash. In various implementations, the one or more image sensor systems 514 further include an on-camera image signal processor (ISP) configured to execute a plurality of processing operations on the image data.

In some implementations, the device 500 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 500 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 500.

The memory 520 includes high-speed random-access memory, such as DRAM, SRAM, DDR RAM, or other random-access solid-state memory devices. In some implementations, the memory 520 includes non-volatile memory, such as one or more magnetic disk storage devices, optical disk storage devices, flash memory devices, or other non-volatile solid-state storage devices. The memory 520 optionally includes one or more storage devices remotely located from the one or more processing units 502. The memory 520 includes a non-transitory computer readable storage medium.

In some implementations, the memory 520 or the non-transitory computer readable storage medium of the memory 520 stores an optional operating system 530 and one or more instruction set(s) 540. The operating system 530 includes procedures for handling various basic system services and for performing hardware dependent tasks. In some implementations, the instruction set(s) 540 include executable software defined by binary information stored in the form of electrical charge. In some implementations, the instruction set(s) 540 are software that is executable by the one or more processing units 502 to carry out one or more of the techniques described herein.

The instruction set(s) 540 includes a parallel plane projection instruction set 542, a parallel plane movement instruction set 544, and a cursor presentation instruction set 546. The instruction set(s) 540 may be embodied as a single software executable or multiple software executables.

The parallel plane projection instruction set 542 is configured with instructions executable by a processor to generate a parallel plane model. For example, the parallel plane instruction set 542 can assess parallel plane data and environmental capture data to generate a parallel plane model comprising a 2D representation of an XR environment.

The parallel plane movement instruction set 544 is configured with instructions executable by a processor to obtain and assess the parallel plane model from parallel plane projection instruction set 542 to detect cursor movement between objects within an XR environment.

The cursor presentation instruction set 546 is configured with instructions executable by a processor to present movement of a cursor on an object of XR environment.

Although the instruction set(s) 540 are shown as residing on a single device, it should be understood that in other implementations, any combination of the elements may be located in separate computing devices. Moreover, FIG. 5 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Returning to FIG. 1, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” maybe construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” maybe construed to mean “upon determining” or “in response to determining” or “in accordance with a determination” or “upon detecting” or “in response to detecting” that the stated condition precedent is true, depending on the context.

What is claimed is:

1. A method comprising:
at an electronic device having a processor and a display:
detecting a first object comprising a first surface and a second object comprising a second surface in a view of a three-dimensional (3D) environment, wherein the first object is separated from second object by a gap located between the first object and the second object;
displaying a movement of a cursor across the first surface of the first object in the view of the 3D environment via the display;
determining that the movement of the cursor approaches or intersects a boundary of the first surface at a first position; and
in accordance with determining that the movement of the cursor approaches or intersects the boundary of the first surface:
determining a second position on the second surface of a second object in the 3D environment based on a path of the cursor with respect an intersection point of a boundary of the second surface; and
moving the cursor from the first position to the second position by discontinuing display of the cursor at the first position and initiating display of the cursor at the second position without displaying the cursor within the gap.

2. The method of claim 1, wherein the path is a line corresponding to the cursor movement on an orthographic projection of the first surface and the second surface.

3. The method of claim 2, wherein the path is a line based on extending a line segment corresponding to the cursor movement on the orthographic projection.

4. The method of claim 3, wherein a direction of the line segment is modified within a bounded area with respect to a position of the second surface of the second object.

5. The method of claim 2, wherein the orthogonal projection is onto a plane that is independent of a user viewpoint.

6. The method of claim 2, wherein the orthographic projection is onto a plane defined based on an orientation of a user interface object.

7. The method of claim 1, wherein the cursor is an indicator showing positions of user interaction within the 3D environment responsive to user input.

8. The method of claim 1, wherein the first object or the second object are flat user-interface objects.

9. The method of claim 1, wherein the first object or the second object are 3D user-interface objects.

10. The method of claim 1, wherein the first surface and second surface are separate by the gap comprising a non-contiguous distance from one another within the 3D environment.

11. The method of claim 1, wherein the first surface and second surface are flat surfaces that are separated by the gap comprising a non-contiguous distance from one another in the 3D environment and oriented in different directions.

12. The method of claim 1 further comprising initially displaying the cursor at an initial position on the first surface in response to a gaze or head pose of a user.

13. An electronic device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the electronic device to perform operations comprising:
detecting a first object comprising a first surface and a second object comprising a second surface in a view of a three-dimensional (3D) environment, wherein the first object is separated from second object by a gap located between the first object and the second object;
displaying a movement of a cursor across a first surface of a first object in a view of a three-dimensional (3D) environment via a display of the electronic device;
determining that the movement of the cursor approaches or intersects a boundary of the first surface at a first position; and
in accordance with determining that the movement of the cursor approaches or intersects the boundary of the first surface:
determining a second position on a second surface of a second object in the 3D environment based on a path of the cursor with respect an intersection point of a boundary of the second surface; and
moving the cursor from the first position to the second position by discontinuing display of the cursor at the first position and initiating display of the cursor at the second position without displaying the cursor within the gap.

14. The electronic device of claim 13, wherein the path is a line corresponding to the cursor movement on an orthographic projection of the first surface and the second surface.

15. The electronic device of claim 14, wherein the path is a line based on extending a line segment corresponding to the cursor movement on the orthographic projection.

16. The electronic device of claim 15, wherein a direction of the line segment is modified within a bounded area with respect to a position of the second surface of the second object.

17. The electronic device of claim 14, wherein the orthogonal projection is onto a plane that is independent of a user viewpoint.

18. The electronic device of claim 14, wherein the orthographic projection is onto a plane defined based on an orientation of a user interface object.

19. The electronic device of claim 13, wherein the cursor is an indicator showing positions of user interaction within the 3D environment responsive to user input.

20. A non-transitory computer-readable storage medium, storing program instructions executable by one or more processors to perform operations comprising:
at an electronic device having the one or more processors and a display:
detecting a first object comprising a first surface and a second object comprising a second surface in a view of a three-dimensional (3D) environment, wherein the first object is separated from second object by a gap located between the first object and the second object;
displaying a movement of a cursor across a first surface of a first object in a view of a three-dimensional (3D) environment via the display of the electronic device;
determining that the movement of the cursor approaches or intersects a boundary of the first surface at a first position; and
in accordance with determining that the movement of the cursor approaches or intersects the boundary of the first surface:
determining a second position on a second surface of a second object in the 3D environment based on a path of the cursor with respect an intersection point of a boundary of the second surface; and
moving the cursor from the first position to the second position by discontinuing display of the cursor at the first position and initiating display of the cursor at the second position without displaying the cursor within the gap.
